(19) United States
(12) Patent Application Publication
(10) Pub. No.: US 2009/0211888 A1
(43) Pub. Date: Aug. 27, 2009

(54) MULTI-ILLUMINATING KEYBOARD BACK LIGHT AND METHOD

(75) Inventors: Toshisada Takeda, Simi Valley, CA (US); Wataru Kudo, Yokohama City (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MINEBEA CO., LTD., Nagano (JP)

(21) Appl. No.: 12/245,565

(22) Filed: Oct. 3, 2008

Related U.S. Application Data
(60) Provisional application No. 60/977,762, filed on Oct. 5, 2007.

(51) Int. Cl. H01H 9/00; H05B 37/00; H01J 9/00

(52) U.S. Cl. 200/310; 315/161; 445/58

(57) ABSTRACT

A keyboard apparatus includes a housing which includes a plurality of key pads spatially disposed within the housing, each of the key pads being depressible upon touch by a user, the plurality of key pads being distributed in a plurality of non-overlapping keyboard regions. Each of the non-overlapping regions includes fewer than all of the plurality of keypads. An optically transparent circuit board is coupled to a backside of each of the key pads. In a specific embodiment, a plurality of electroluminescent segments are arranged in a non-planar configuration. Each of the plurality of electroluminescent segments includes one of a corresponding plurality of power supply devices. Each of the plurality of electroluminescent segments provides electromagnetic radiation to a respective non-overlapping keyboard region for lighting key pads in the respective non-overlapping keyboard region. Each of the non-overlapping regions includes fewer than all of the plurality of keypads.

### CROSS-REFERENCES TO RELATED APPLICATIONS

This application claims priority to U.S. Provisional Patent Application No. 60/977,762 filed Oct. 5, 2007, which is incorporated herein in its entirety by reference for all purposes. This application is also related to U.S. patent application Ser. No. 12/146,412 filed Jun. 25, 2008, which is commonly assigned and is incorporated herein by reference in its entirety for all purposes.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention is directed to computing devices. More particularly, the invention provides a keyboard apparatus and related methods having a backlighting characteristic for lighting one or more keys. Merely by way of example, the invention has been applied to a keyboard apparatus for a desk top computer, although it can also be applied to a laptop computer, modular computer, and other computing devices.

Computing devices have proliferated. In the early days, large mainframe computers dominated the computing landscape. These large mainframe computers were developed by companies such as IBM Corporation of Armonk, N.Y. Mainframe computers have been replaced, at least in part, by smaller computing devices, commonly known as “PCs.” PCs come in various shapes and sizes. PCs are often run using computer software such as XP™ from Microsoft Corporation from Redmond Wash. Other types of computer software come from Apple Computer of Cupertino, Calif. Smaller PC versions are often called “lap top computers.” Other types of PCs include larger desktop versions. Still other versions of PCs can be found in smaller devices such as personal digital assistants, called PDAs, cellular phones, and a variety of other applications.

All of these computing devices generally require input devices for human users to interact with them. As merely an example, computer keyboards are most commonly used as such input devices for inputting characters, numerals and symbols to electronic devices, particularly to these computing devices such as the PCs. While such keyboards are generally useful in lighted buildings, they may be difficult to use in a darker setting. As an example, such darker setting may be inside an airplane, which has been dimmed. Additionally, the larger setting may be in an unlighted building or other unlighted environment. To overcome these darker settings, certain keyboard devices have been lighted using various lighting techniques. These lighting techniques include use of individual light emitting diodes to emit light to individual key pads. Alternatively, light emitting crystals in the form of illuminating materials have been used to emit light to individual key pads. Various other techniques have been proposed. Unfortunately, these techniques have many limitations, which will be described throughout the present specification and more particularly below.

From the above, it is seen that techniques for improving keyboards for computing devices are highly desirable.

### BRIEF SUMMARY OF THE INVENTION

According to the present invention, techniques for computing devices are provided. More particularly, the invention provides a keyboard apparatus and related methods having a backlighting characteristic for lighting one or more keys. Merely by way of example, the invention has been applied to a keyboard apparatus for a desk top computer, although it can also be applied to a laptop computer, modular computer, and other computing devices.

In a specific embodiment, the present invention provides an electroluminescent apparatus. The electroluminescent apparatus includes a protection layer characterized by two or more non-overlapping regions and a back electrode layer, the back electrode layer including two or more back electrode regions. Each of the two or more back electrode regions overlies a corresponding one of the two or more non-overlapping regions in the protection layer. The electroluminescent apparatus also includes a bottom insulation layer, which includes two or more bottom insulation regions. Each of the two or more bottom insulating regions overlies a corresponding one of the back electrode regions. The electroluminescent apparatus also includes two or more electroluminescent segments, each of which overlying a corresponding one of the back electrode layers. The apparatus includes a transparent electrode layer which includes two or more transparent electrode regions. Each of the two or more transparent electrode regions overlies a corresponding one of electroluminescent segments. The electroluminescent apparatus also includes two or more power supply devices, each of which being coupled to a corresponding one of the back electrode regions and being coupled to a corresponding one of the transparent electrode regions for providing luminescence over a corresponding one of the non-overlapping regions.

In a specific embodiment of the electroluminescent apparatus, the luminescent segments includes a phosphor-containing material. In an embodiment, the electroluminescent apparatus also includes a first conductive material between two adjacent transparent electrode regions in the transparent electrode layer, the first conductive material being electrically grounded to insulate the two adjacent transparent electrode regions. In another embodiment, the electroluminescent apparatus includes a second conductive material between two adjacent back electrode regions in the back electrode layer, the second conductive material being electrically grounded to insulate the two adjacent back electrode regions. In an embodiment, the electroluminescent apparatus includes a first conductive material between two adjacent transparent electrode regions in the transparent electrode layer, the first conductive material being electrically grounded to insulate the two adjacent transparent electrode regions, and a second conductive material between two adjacent back electrode regions in the back electrode layer, the second conductive material being electrically grounded to insulate the two adjacent back electrode regions, wherein the first conductive material is electrically coupled to the second conductive material.

In another specific embodiment of the electroluminescent apparatus, the transparent electrode layer further comprises a second plurality of conductive material, each of the second plurality of conductive material being disposed between each pair of adjacent transparent electrode regions in the transparent electrode layer, second plurality of conductive material being electrically grounded. In another embodiment, the back electrode layer further comprises a second plurality of conductive material, each of the second plurality of conductive material being disposed between each pair of adjacent back electrode regions in the back electrode layer, each of the second plurality of conductive material being electrically grounded.

According to another embodiment of the invention an electroluminescent apparatus is provided. The apparatus includes a protection layer characterized by two or more non-overlapping regions; a back electrode layer, the back electrode layer including two or more back electrode regions, each of the two or more back electrode regions overlying a corresponding one of the two or more non-overlapping regions in the protection layer; a bottom insulation layer, a bottom insulation layer including two or more bottom insulation regions, each of the two or more bottom insulating regions overlying a corresponding one of the back electrode regions; a phosphor layer, the phosphor layer including two or more of phosphor regions, each of the two or more phosphor regions overlying a corresponding one of the back electrode layers; a transparent electrode layer, the transparent electrode layer including two or more transparent electrode regions, each of the two or more transparent electrode region overlying a corresponding one of the phosphor regions; and two or more power supply devices, each of the two or more power supply devices being coupled to a corresponding one of the back electrode regions and a corresponding one of the transparent electrode regions for providing luminescence over a corresponding one of the non-overlapping regions.

In an alternative embodiment, the invention provides a keyboard apparatus which includes a housing. A first plurality of key pads are spatially disposed within the housing. Each of the key pads is depressible upon touch by a user. The first plurality of key pads are distributed in a second plurality of non-overlapping keyboard regions. The keyboard includes an optically transparent circuit board coupled to a backside of each of the key pads. The keyboard also includes a luminescent apparatus which includes a second plurality of electroluminescent segments in a substantially non-planar configuration. Each of the second plurality of electroluminescent segments includes one of a corresponding plurality of power supply devices. Each of the second plurality of electroluminescent segments provides electromagnetic radiation to a respective non-overlapping keyboard region for lighting key pads in the respective non-overlapping keyboard region.

In another specific embodiment, the invention provides a keyboard apparatus which includes a housing. A first plurality of key pads spatially disposed within the housing. Each of the key pads is depressible upon touch by a user. The first plurality of key pads are distributed in a first plurality of non-overlapping keyboard regions. Each of the non-overlapping regions includes fewer than all of the first plurality of keypads. The keyboard apparatus includes an optically transparent circuit board coupled to a backside of each of the key pads and a first plurality of electroluminescent segments arranged in a non-planar configuration. Each of the first plurality of electroluminescent segments includes one of a corresponding plurality of power supply devices. Each of the first plurality of electroluminescent segments provides electromagnetic radiation to a respective non-overlapping keyboard region for lighting key pads in the respective non-overlapping keyboard region. Each of the non-overlapping regions includes fewer than all of the first plurality of keypads. Accordingly, each of the first plurality of electroluminescent segments provides electromagnetic radiation for lighting fewer than all of the first plurality of keypads.

In yet another embodiment, the invention provides a keyboard apparatus which includes a housing. A first plurality of key pads are spatially disposed within the housing. Each of the key pads is depressible upon touch by a user. The first plurality of key pads are distributed in a second plurality of non-overlapping keyboard regions. Each of the non-overlapping regions includes fewer than all of the first plurality of keypads. The keyboard apparatus includes an optically transparent circuit board coupled to a backside of each of the key pads and a luminescent apparatus. The luminescent apparatus includes a second plurality of electroluminescent segments, each of which includes one of a corresponding plurality of power supply devices. Each of the second plurality of electroluminescent segments provides electromagnetic radiation to a respective non-overlapping keyboard region for lighting key pads in the respective non-overlapping keyboard region. Each of the non-overlapping regions including fewer than all of the first plurality of keypads; that is, each of the first plurality of electroluminescent segments provides electromagnetic radiation for lighting fewer than all of the first plurality of keypads.

According to another embodiment, the method provides a method for manufacturing a luminescent device for a keyboard apparatus. The method includes the following processes.
1. Provide a protection layer characterized by two or more non-overlapping regions;
2. Provide a back electrode layer, the back electrode layer including two or more back electrode regions, each of the two or more back electrode regions overlying a corresponding one of the two or more non-overlapping regions in the protection layer;
3. Add a bottom insulation layer, a bottom insulation layer including two or more bottom insulation regions, each of the two or more bottom insulating regions overlying a corresponding one of the back electrode regions;
4. Add two or more phosphor segments, each of the two or more phosphor segments overlying a corresponding one of the back electrode layers;
5. Add a transparent electrode layer, the transparent electrode layer including two or more transparent electrode regions, each of the two or more transparent electrode region overlying a corresponding one of the phosphor regions; and
6. Provide two or more power supply devices, each of the two or more power supply devices being coupled to a corresponding one of the back electrode regions and a corresponding one of the transparent electrode regions for providing luminescence over a corresponding one of the non-overlapping regions.

In yet another alternative embodiment, the invention provides a method for making a keyboard apparatus. The method includes the following processes.
1. Provide a housing including a first plurality of key pads spatially disposed within the housing, each of the key pads being depressible upon touch by a user, the first plurality of key pads being distributed in a second plurality of non-overlapping keyboard regions;
2. Provide an optically transparent circuit board coupled to a backside of each of the key pads; and
3. Provide a luminescent apparatus including a second plurality of electroluminescent segments in a substantially non-planar configuration, each of the second plurality of electroluminescent segments including one of a corresponding plurality of power supply devices, each of the second plurality of electroluminescent segments providing electromagnetic radiation to a respective non-overlapping keyboard region for lighting key pads in the respective non-overlapping keyboard region.

According to an alternative embodiment, the method provides an electroluminescent apparatus. The apparatus includes a transparent protection layer characterized by two or more non-overlapping regions. The apparatus also includes a transparent electrode layer which includes two or more transparent electrode regions. Each of the two or more transparent electrode region is coupled to a corresponding one of the two or more non-overlapping regions. The apparatus further includes two or more electroluminescent sections, each of which is coupled to a corresponding one of the two or more transparent electrode regions. Additionally, the apparatus includes a dielectric layer, which includes two or more dielectric regions, each of the two or more dielectric regions coupled to a corresponding one of the electroluminescent segments. The apparatus also includes a back electrode layer, which includes two or more back electrode regions, each of which is coupled to a corresponding one of the two or more dielectric regions. The apparatus also includes two or more power supply devices. Each of the two or more power supply devices is coupled to a corresponding one of the back electrode regions and being coupled to a corresponding one of the transparent electrode regions for providing luminescence over a corresponding one of the non-overlapping regions. In an example, each of the power supply devices is a DC to AC inverter.

In a specific embodiment of the electroluminescent apparatus, at least one of the two or more electroluminescent sections is characterized by a first color and at least another one of the two or more electroluminescent sections is characterized by a second color. The first color is different from the second color. In another embodiment, a first one of the two or more power supply devices provides a first voltage and a second one of the two or more power supply devices provides a second voltage, the first voltage being different from the second voltage. In an embodiment, the first voltage and the second voltage provide substantially similar luminescent brightness in corresponding first and second non-overlapping regions. In another embodiment, a first one of the two or more power supply devices provides a first AC voltage characterized by a first frequency and a second one of the two or more power supply devices provides a second AC voltage characterized by a second frequency, the first frequency being different from the second frequency. In yet another embodiment, the first AC voltage and the second AC voltage provides substantially similar luminescent brightness in corresponding first and second non-overlapping regions. In a specific embodiment, the electroluminescent apparatus of also includes a capacitor coupled to a corresponding transparent electrode region and a corresponding back electrode region for fine-tuning luminescent brightness over a corresponding one of the non-overlapping regions.

According to another embodiment of the invention, a method for manufacturing a luminescent device for a keyboard apparatus can be outline below.
1. providing a transparent protection layer characterized by two or more non-overlapping regions;
2. printing a transparent electrode layer on the transparent protection layer, the transparent electrode layer including two or more transparent electrode regions, each of the two or more transparent electrode region coupled to a corresponding one of the two or more non-overlapping regions;
3. printing two or more electroluminescent sections on the transparent electrode layer, each of the two or more electroluminescent sections coupled to a corresponding one of the two or more transparent electrode regions;
4. printing a dielectric layer on the two or more electroluminescent sections, the dielectric layer including two or more dielectric regions, each of the two or more dielectric regions coupled to a corresponding one of the electroluminescent segments;
5. printing a back electrode layer, the back electrode layer including two or more back electrode regions, each of the two or more back electrode regions coupled to a corresponding one of the two or more dielectric regions; and
6. adding two or more power supply devices, each of the two or more power supply devices being coupled to a corresponding one of the back electrode regions and being coupled to a corresponding one of the transparent electrode regions for providing luminescence over a corresponding one of the non-overlapping regions.

In an embodiment, the method also includes printing an insulator layer covering the back electrode layer, the dielectric layer, the electroluminescent sections, and the transparent electrode layer. In some embodiments, the printing process includes a screen printing process. In an embodiment, at least one of the two or more electroluminescent sections is characterized by a first color and at least another one of the two or more electroluminescent sections is characterized by a second color, the first color being different from the second color.

In a specific embodiment, a first one of the two or more power supply devices provides a first voltage and a second one of the two or more power supply devices provides a second voltage, the first voltage being different from the second voltage. In an embodiment, the first voltage and the second voltage provide substantially similar luminescent brightness in corresponding first and second non-overlapping regions. In an embodiment, a first one of the two or more power supply devices provides a first AC voltage characterized by a first frequency and a second one of the two or more power supply devices provides a second AC voltage characterized by a second frequency, the first frequency being different from the second frequency. In a specific embodiment, the first AC voltage and the second AC voltage provides substantially similar luminescent brightness in corresponding first and second non-overlapping regions.

In an embodiment, the method also includes adding a capacitor coupled to a corresponding transparent electrode region and a corresponding back electrode region for fine-tuning luminescent brightness over a corresponding one of the non-overlapping regions. In an embodiment, the method also includes providing a first conductive material between two adjacent transparent electrode regions in the transparent electrode layer, the first conductive material being electrically grounded to insulate the two adjacent transparent electrode regions. In another embodiment, the method includes providing a second conductive material between two adjacent back electrode regions in the back electrode layer, the second conductive material being electrically grounded to insulate the two adjacent back electrode regions.

In another embodiment, the method provides ground connections, which includes the following processes:
1. providing a first conductive material between two adjacent transparent electrode regions in the transparent electrode layer, the first conductive material being electrically grounded to insulate the two adjacent transparent electrode regions;
2. adding a second conductive material between two adjacent back electrode regions in the back electrode layer, the second conductive material being electrically grounded to insulate the two adjacent back electrode regions; and
3. coupling the first conductive material electrically to the second conductive material.

In another embodiment, the transparent electrode layer further comprises a second plurality of conductive material, each of the second plurality of conductive material being disposed between each pair of adjacent transparent electrode regions in the transparent electrode layer, second plurality of conductive material being electrically grounded In yet another embodiment, the back electrode layer further includes a second plurality of conductive material, each of the second plurality of conductive material being disposed between each pair of adjacent back electrode regions in the back electrode layer, each of the second plurality of conductive material being electrically grounded. In a specific embodiment, each of the two or more power supply devices comprises a DC-to-AC inverter.

Many benefits are achieved by way of this invention. One or more benefits can be achieved in one or more of the embodiments.
1. Efficient back light source including separate luminescent segments, which may be non-planar, providing lighting to different regions of a keyboard;
2. Thinner and smaller power supply system for providing AC power to the luminescent segments;
3. Improved electrical connection techniques for isolation separate regions and compensating for variations in the manufacturing of the luminescent segments;
4. Separate segments and independent drivers coupled to each region for providing uniform illumination for non-planar configurations;
5. Different colors provided in each luminescent segment;
6. A capacitor coupled to each luminescent segment for adjusting brightness; and
7. A method for adjusting the electric field strength and frequency of the AC voltages associated with each luminescent segment.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of a keyboard apparatus according to an embodiment of the present invention;

FIG. 2 is a simplified diagram of an electroluminescent segment according to an embodiment of the present invention;

FIG. 3 is a simplified diagram of a luminescent apparatus according to an embodiment of the present invention;

FIG. 4 is a simplified diagram of a of power supply connected to a electroluminescent device e according to an embodiment of the present invention;

FIG. 5 is a simplified diagram of a power supply system for a luminescent apparatus according to an embodiment of the present invention;

FIG. 6 is a simplified diagram for a matching circuit for a power supply system according to an embodiment of the present invention;

FIG. 7 is a simplified diagram of a method for a keyboard according to an embodiment of the present invention;

FIG. 8 is a simplified cross-sectional view diagram of a luminescent apparatus according to an alternative embodiment of the present invention; and

FIG. 9 is a simplified flow chart illustrating a method for making a keyboard apparatus according to an embodiment of the present invention.

### DETAILED DESCRIPTION OF THE INVENTION

According to the present invention, techniques for computing devices are provided. More particularly, the invention provides a keyboard apparatus and related methods having a backlighting characteristic for lighting one or more keys. Merely by way of example, the invention has been applied to a keyboard apparatus for a desk top computer, although it can also be applied to a laptop computer, modular computer, and other computing devices.

Depending upon the embodiment, the present invention includes one or more of various features, which may be used. These features include the following:
1. An efficient back light source including separate luminescent segments providing lighting to different regions of a keyboard;
2. A technique for smaller and thinner power supply system for providing AC power to the luminescent segments;
3. Improved electrical connection techniques for isolation separate regions and compensating for variations in the manufacturing of the luminescent segments;
4. Separate segments and independent drivers coupled to each region for providing uniform illumination for non-planar configurations;
5. Different colors can be provided in each luminescent segment;
6. A capacitor is coupled to each luminescent segment for adjusting brightness; and
7. A method for adjusting the electric field strength and frequency of the AC voltages associated with each luminescent segment.

As shown, the above features may be in one or more of the embodiments to follow. These features are merely examples, which should not unduly limit the scope of the claims herein. One of ordinary skill in the art would recognize many variations, modifications, and alternatives.

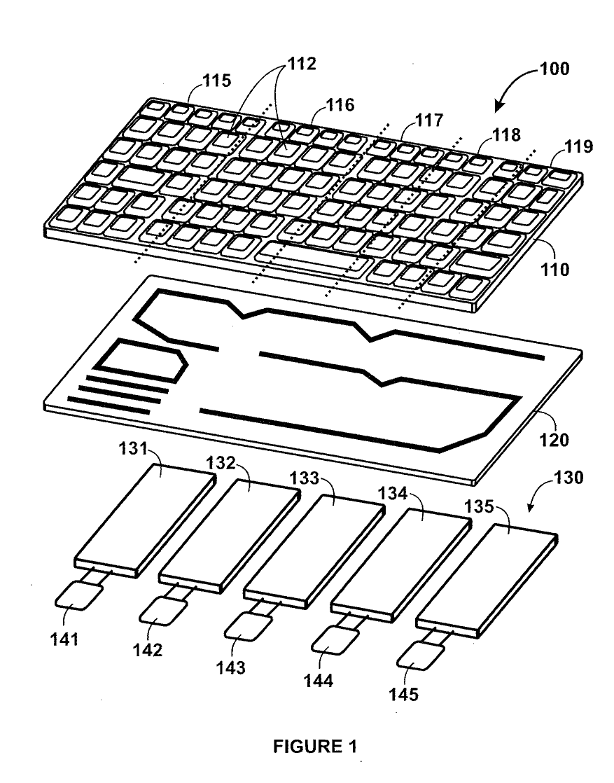

FIG. 1 is a simplified diagram of a keyboard apparatus 100 according to an embodiment of the present invention. This diagram is merely an example, which should not unduly limit the scope of the claims herein. One of ordinary skill in the art would recognize other variations, modifications, and alternatives. As shown, keyboard apparatus 100 includes a housing 110. The housing includes a number of key pads 112 spatially disposed within the housing. Each of the key pads is depressable upon touch by a user. In an embodiment of the present invention, the housing 110 includes at least twenty-six key pads. In a specific embodiment, keyboard apparatus 100 includes twenty-six alphanumeric key pads typically used in a computer keyboard, for example, in a PC or a notebook computer. In an embodiment, key pads 112 are distributed in a second plurality of non-overlapping keyboard regions, such as 115, 116, . . . , 119. The keyboard apparatus 100 also includes an optically transparent circuit board 120 coupled to a backside of each of the key pads. In a specific embodiment, each key pad is coupled to the circuit board through a scissor switch, which activates a circuit to identify which particular keypad is being depressed by a user.

In a specific embodiment, key board apparatus 100 also includes a luminescent apparatus 130. In an embodiment, luminescent apparatus includes multiple electroluminescent segments, 131, 132, . . . , 135, etc. Each of the electroluminescent segments includes one of a corresponding plurality of power supply devices 141, 142, . . . , 145. Each of the electroluminescent segments provides electromagnetic radiation to a respective non-overlapping keyboard region for lighting key pads in the respective non-overlapping keyboard region 115, 116, . . . , 119.

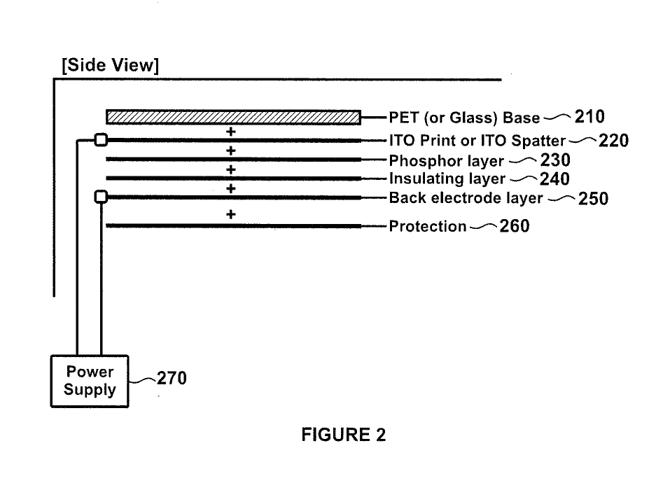

FIG. 2 is a simplified cross-sectional view diagram of an electroluminescent segment 200 according to an embodiment of the present invention. This diagram is merely an example, which should not unduly limit the scope of the claims herein. One of ordinary skill in the art would recognize other variations, modifications, and alternatives. In an embodiment, electroluminescent segment 200 may be used in keyboard 100 as one the electroluminescent segments 131-135. As shown, electroluminescent segment 200 includes a PET or glass base layer 210, an ITO layer which is used as a front electrode, a phosphor layer 230, an insulating layer 240, a back electrode layer 250, and a protection layer 260. In a specific embodiment, the ITO layer and the back electrode layer are coupled to a power supply 270. An AC signal from power supply 270 is applied between the ITO layer and the back electrode layer, causing light to be produced from the phosphor material.

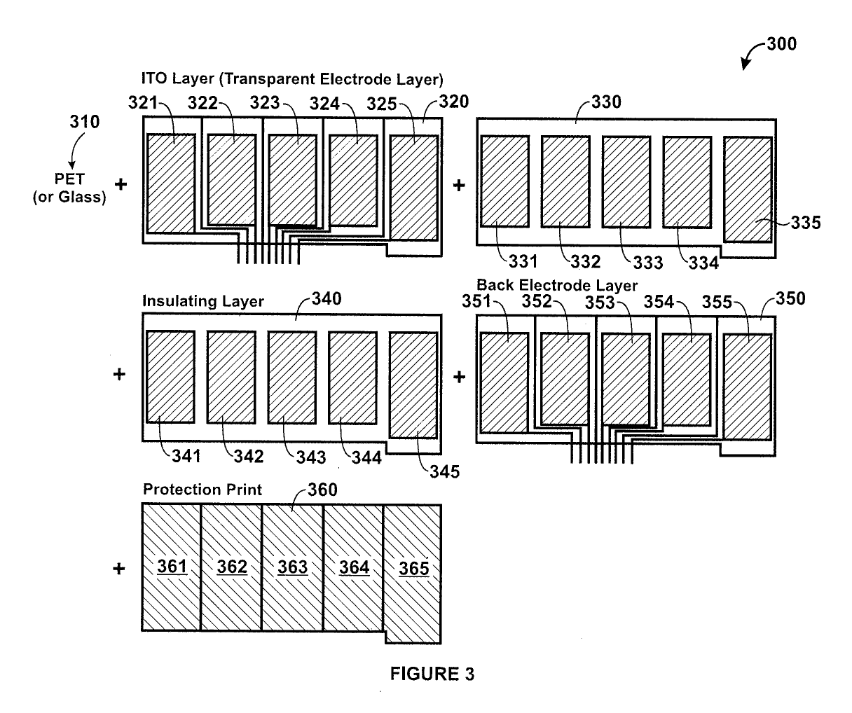

FIG. 3 is a simplified diagram of a luminescent apparatus 300 according to an embodiment of the present invention. This diagram is merely an example, which should not unduly limit the scope of the claims herein. One of ordinary skill in the art would recognize other variations, modifications, and alternatives. As shown, luminescent apparatus 300 includes a protection layer 360 characterized by two or more non-overlapping regions, such as 361, 361, . . . , 365. In an embodiment, these regions are not physically divided regions of the protective layer, rather these regions mark the location of subsequent components of luminescent apparatus 300.

In an embodiment, luminescent apparatus 300 includes a back electrode layer 350, which includes two or more back electrode regions such as 351, 351, . . . , 355. Each of the back electrode regions overlying a corresponding one of the two or more non-overlapping regions in the protection layer 361, 361, . . . , 365. In an embodiment, luminescent apparatus 300 also includes a bottom insulation layer, a bottom insulation layer including two or more bottom insulation regions, each of the two or more bottom insulating regions overlying a corresponding one of the back electrode regions. In a specific embodiment luminescent apparatus 300 includes an insulation layer, which includes multiple insulating regions, 341, 342, . . . , 345. In an embodiment, luminescent apparatus 300 also includes two or more of phosphor regions 331, 332, . . . , 335, each of phosphor regions overlying a corresponding one of the back electrode layers.

In an embodiment, luminescent apparatus 300 includes a transparent electrode layer 320. In a specific embodiment, transparent electrode layer 320 may be an ITO layer. The transparent electrode layer 320 includes two or more transparent electrode regions 321, 322, . . . , 325. Each of the two or more transparent electrode regions overlies a corresponding one of the phosphor regions. In an embodiment, luminescent apparatus 300 also includes two or more power supply devices (not shown in FIG. 3). Each of the two or more power supply devices is coupled to a corresponding one of the back electrode regions and a corresponding one of the transparent electrode regions for providing luminescence over a corresponding one of the non-overlapping regions.

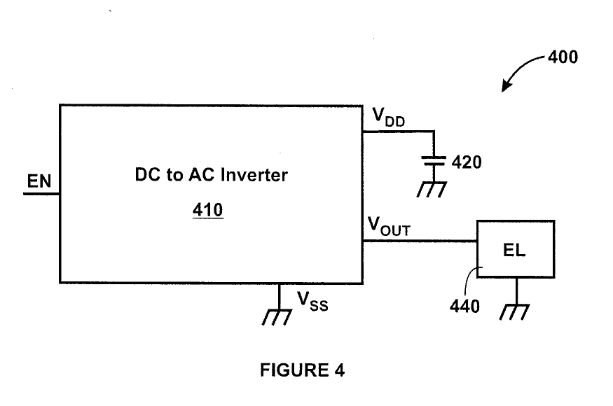

FIG. 4 is a simplified diagram of a of power supply connected to an electroluminescent device e according to an embodiment of the present invention. This diagram is merely an example, which should not unduly limit the scope of the claims herein. One of ordinary skill in the art would recognize other variations, modifications, and alternatives. As shown, power supply 400 includes a DC to AC inverter 410. DC to AC inverter 410 receives a DC power input from terminal VDD. In a specific example, power input may be a DC battery, for example, a 3.3 V battery. Of course other DC power sources can also be used. DC to AC inverter 410 includes an EN terminal for receiving an control signal and a Vss terminal for providing a ground connection. DC to AC inverter 410 also includes an output terminal Vout for providing AC power to an electroluminescent device 440.

In a conventional keyboard using electroluminescent device, the DC to AC power is required to supply power to complete keyboard. Consequently, the DC to AC inverter is often large and bulky, and tends to be inefficient. These drawbacks can limit the application of electroluminescent devices in portable electronic devices, such as notebook computers. Accordingly, it is desirable to have an improved technique for providing power to luminescent devices for key board apparatus.

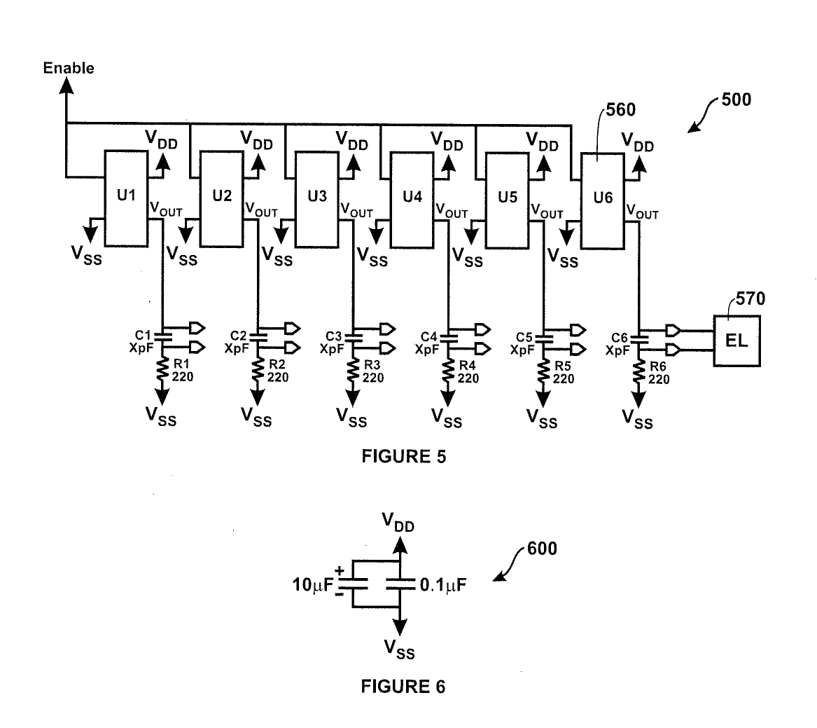

FIG. 5 is a simplified diagram of a power supply system 500 for a luminescent apparatus according to an embodiment of the present invention. This diagram is merely an example, which should not unduly limit the scope of the claims herein. One of ordinary skill in the art would recognize other variations, modifications, and alternatives. As shown, power supply system 500 includes power supply units U1, U2, U3, . . . , U6. In an embodiment, each of the power supply units U1, U2, U3, . . . , U6 may be similar to power supply 400 discussed above. For example, power supply unit U6 (560) includes a terminal for receiving an Enable signal, a VDD terminal for receiving a DC power input, a Vss terminal for ground connection, and a Vout signal for providing an AC power supply to an electroluminescent device 570. As shown, Vout is also coupled to capacitor C6 and resistor R6. In an embodiment, capacitor C6 provides a matching function.

In a specific embodiment, power supply system 500 may be coupled to keyboard 100 as shown in FIG. 1. Keyboard 100 may include luminescent apparatus as described above in connection with FIGS. 2 and 3. In an embodiment, the luminescent apparatus may include electroluminescent segments, each coupled to a power supply unit of power supply system 500. Each of the power supply units can be made smaller and thinner. Such a luminescent apparatus can be advantageously used in a portable computing system. Additionally, it is often difficult to provide uniform illumination to computer keyboards. Some keyboards may have a non-planar configuration. Some keyboards may include components, such as circuit boards, that are not uniform. Other keyboards may include non-uniform light sources. In some embodiments of the invention, a separate segments and an independent driver are coupled to each region for providing uniform illumination for non-planar configurations. Of course, there can be other variations, modifications, and alternatives.

FIG. 6 is a simplified diagram for a matching circuit 600 for a power supply system according to an embodiment of the present invention. This diagram is merely an example, which should not unduly limit the scope of the claims herein. One of ordinary skill in the art would recognize other variations, modifications, and alternatives. As shown, two capacitors are coupled in parallel between the VDD terminal and Vss terminal of a power supply unit such as 560 in FIG. 5. Circuit 600 can be used to reduce the adverse effect resulting from variations in the capacitance of individual luminescent devices.

As discussed above, an electroluminescent (EL) device is operated using an AC power supply. An inverter will convert from DC to AC. The EL luminescence timing is related to EL (Capacitance). As it is difficult to obtain the exactly same capacitance between the separated EL because of inherent variations in the manufacturing process. Therefore, even if we send ON-Off cycle same time, there will be timing difference among the separate EL's. According to an embodiment of the invention, a method is provided for using ground connections to minimize the negative effect.

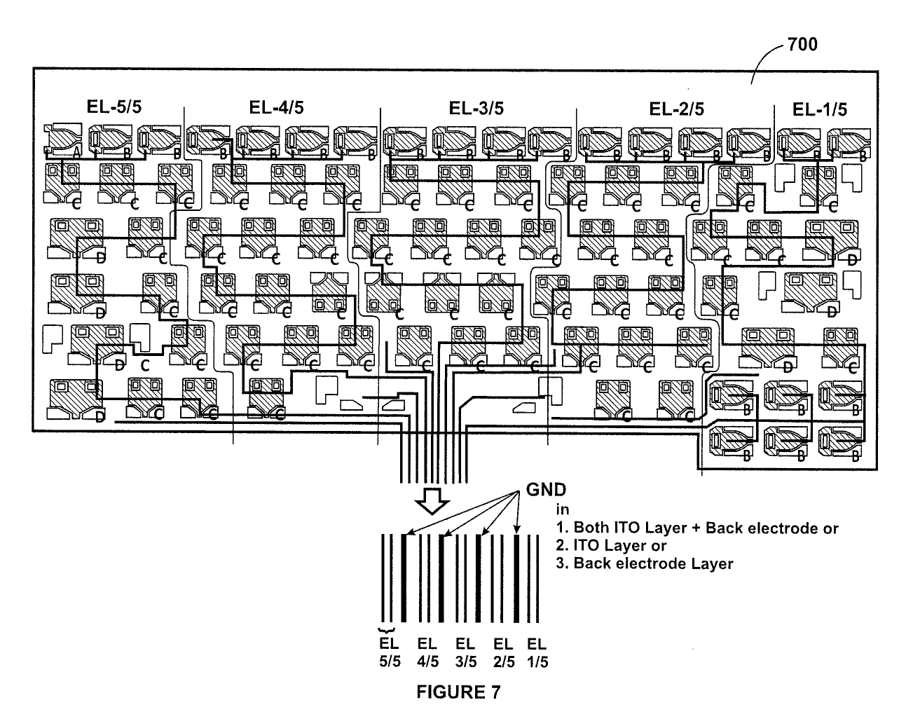

FIG. 7 is a simplified diagram illustrating a method for a keyboard 700 according to an embodiment of the present invention. This diagram is merely an example, which should not unduly limit the scope of the claims herein. One of ordinary skill in the art would recognize other variations, modifications, and alternatives. As shown, the keyboard 700 includes regions marked as EL 1/5, EL 2/5, . . . , EL 5/5. Each region includes an electroluminescent segment for provide lighting to key caps in each region. In an embodiment, an electrical ground connection is provided in each region. These ground connections allow electrical noise insulation between the regions. In an embodiment, the ground connections are provided in the ITO layer. In another embodiment, the ground connection is provided in the ITO layer. In an alternative embodiment, the ground connections are provided in both the ITO and the back electrode layer. In yet another embodiment, the ground connections in the ITO layer and the back electrode layer are coupled together. Of course, there can be other variations and alternatives.

As shown, the electroluminescent segments are used as a backlight member in keyboard 700. As shown in FIGS. 1-3, the electroluminescent segments are arranged a substantially non-planar configuration, including each of the electrode members and overlying cap layer according to a specific embodiment. Each of the power supply device can selectively provide voltages to cause changes in illumination in each of the regions according to a specific embodiment. Although the luminescent apparatus is non-planar, it can be selectively driven to cause an appearance of planar illumination or patterned illumination or any combination of these, and the like. Of course, one of ordinary skill in the art would recognize other variations, modifications, and alternatives.

Although the above has been illustrated in terms of specific hardware features, it would be recognized that many variations, alternatives, and modifications can exist. For example, any of the hardware features can be further combined, or even separated. Further details of certain methods according to the present invention can be found throughout the present specification.

According to an embodiment of the invention, a method for manufacturing a luminescent device for a keyboard apparatus can be outline below.
1. providing a protection layer characterized by two or more non-overlapping regions;
2. providing a back electrode layer, the back electrode layer including two or more back electrode regions, each of the two or more back electrode regions overlying a corresponding one of the two or more non-overlapping regions in the protection layer,
3. adding a bottom insulation layer, a bottom insulation layer including two or more bottom insulation regions, each of the two or more bottom insulating regions overlying a corresponding one of the back electrode regions;
4. adding two or more phosphor segments, each of the two or more phosphor segments overlying a corresponding one of the back electrode layers;
5. adding a transparent electrode layer, the transparent electrode layer including two or more transparent electrode regions, each of the two or more transparent electrode region overlying a corresponding one of the phosphor regions; and
6. providing two or more power supply devices, each of the two or more power supply devices being coupled to a corresponding one of the back electrode regions and a corresponding one of the transparent electrode regions for providing luminescence over a corresponding one of the non-overlapping regions, the method can be briefly outlined below.

The above sequence of processes provides a method for manufacturing a luminescent device for a keyboard apparatus according to an embodiment of the present invention. As shown, the method uses a combination of processes including providing separate luminescent devices and power supplies to provide lighting to different regions of a keyboard. Other alternatives can also be provided where steps are added, one or more steps are removed, or one or more steps are provided in a different sequence without departing from the scope of the claims herein.

According to another embodiment of the invention, a method for making a keyboard can be outlined as follows.
1. providing a housing including a first plurality of key pads spatially disposed within the housing, each of the key pads being depressible upon touch by a user, the first plurality of key pads being distributed in a second plurality of non-overlapping keyboard regions;
2. providing an optically transparent circuit board coupled to a backside of each of the key pads; and
3. providing a luminescent apparatus including a second plurality of electroluminescent segments, each of the second plurality of electroluminescent segments including one of a corresponding plurality of power supply devices, each of the second plurality of electroluminescent segments providing electromagnetic radiation to a respective non-overlapping keyboard region for lighting key pads in the respective non-overlapping keyboard region.

The above sequence of processes provides a method for manufacturing a luminescent device for a keyboard apparatus according to an embodiment of the present invention. As shown, the method uses a combination of processes including providing separate luminescent devices and power supplies to provide lighting to different regions of a keyboard. Other alternatives can also be provided where steps are added, one or more steps are removed, or one or more steps are provided in a different sequence without departing from the scope of the claims herein.

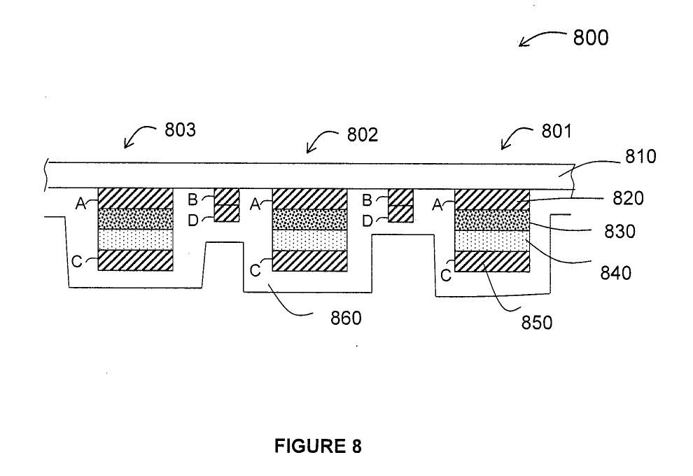

FIG. 8 is a simplified cross-sectional view diagram of a luminescent apparatus according to an alternative embodiment of the present invention. This diagram is merely an example, which should not unduly limit the scope of the claims herein. One of ordinary skill in the art would recognize other variations, modifications, and alternatives. In an embodiment, luminescent apparatus 800 may be used in keyboard 100. As shown, luminescent apparatus 800 includes a protection or substrate layer 810. Depending on the embodiment, layer 810 can be a PET, Mylar, or glass based layer. As shown, layer 810 includes multiple non-overlapping regions, 801, 802, and 803, etc. Luminescent apparatus 800 also includes luminescent segments 805, 806, and 807, etc. Each luminescent segment provides luminescence in each of the regions 801, 802, 803, respectively. When luminescent apparatus 800 is used in keyboard 100, the luminescent segments 805, 806, and 807, etc., may be used as electroluminescent segments 131-135 in FIG. 1.

In FIG. 8, each luminescent segment includes multiple layers of components. As shown, segment 805 includes a transparent electrode layer 820, an electroluminescent section 830, a dielectric layer 840, a back electrode layer 850, and an insulator layer 860. In a specific embodiment, the transparent electrode layer 820 and the back electrode layer 850 are coupled to a power supply (not shown). An AC signal from the power supply is applied between the transparent electrode layer and the back electrode layer, causing light to be produced from the phosphor material.

In FIG. 8, layer 810 is shown as a clear Mylar (PET) sheet. According to a specific embodiment, the luminescent apparatus is made using a printing process. In such a process, a Mylar or PET sheet is first provided as a substrate. In an alternative embodiment, the luminescent apparatus is made using a sputtering process. There a glass substrate is often used.

In FIG. 8, the transparent electrode layer 820, for example, an ITO layer, is used as a front electrode. In a printing process, the transparent electrode, such as ITO, can be printed on the protection layer 810 and form an electrode corresponding to a region in the 810 layer. In an embodiment, ground electrode can also be printed in the same process. As shown in Figure, the front electrodes are marked as A and the ground electrodes are marked as B.

The electroluminescent section 830 is shown in FIG. 8 as a segment of phosphor layer. In an example, the phosphor segments are printed on the transparent electrode layer. In some embodiment, different colors can be provided by having different phosphor materials printed in each region.

The dielectric layer 840 is an insulating material used to supply electric field effectively to the phosphor layer. An AC voltage is applied between the transparent electrode 820 and the back electrode 850 to cause the phosphor layer to illuminate. In an embodiment, the dielectric layer and the back electrode can be formed in each region using printing processes. Optionally, conductive layer D can also be printed to form ground connection lines. In FIG. 8, the ground connection is shown as having both layer D and B. Alternative, either layer B or D can be used to form ground connections.

For protection of the luminescent apparatus, insulator layer 860 is formed to cover the various components as shown in FIG. 8. The insulator layer 860 can also provide protection against exposure to water. In an example, the insulator layer 860 can be formed by a printing process. Alternatively, a lamination process can also be used to form the insulator layer.

In the discussion above, the various layers can be formed by printing processes. For example, a screen printing process can be used. Alternatively, other masked printing process can also be used. Additionally, other processes, such as sputtering, can also be used for form the various layers.

In an embodiment, two or more power supply device, such as DC to AC inverters, are provided to the luminescent apparatus. Each of the two or more power supply devices is coupled to a corresponding one of the back electrode regions and coupled to a corresponding one of the transparent electrode regions for providing luminescence over a corresponding one of the non-overlapping regions.

According to an embodiment of the invention, a capacitor is added in parallel to each electroluminescent segment. The capacitors can be adjusted to provide uniformity in luminescence in each region. In an embodiment, by adjusting the DC input to the inverter circuit, we can adjust the AC output from inverter circuit and in turn adjust the brightness of the illumination in each region. The ability to adjust the brightness in each region is desirable for brightness uniformity, especially when each region has a different color. Even if the brightness in machine measurement is same (cd/m2), blue may seem darker than green for human eyes. Also, even with the same AC voltage, green may appear brighter compared to blue. Accordingly, an embodiment of the invention provides a method for adjusting the capacitor value associated with each electroluminescent segment and adjusting the electric field strength and frequency of the AC input to the electroluminescent segment.

In an embodiment, luminescent apparatus 800 can be used as a backlight member in keyboard 100 in FIG. 1. As shown in FIG. 8, the backlight member 800 has a substantially non-planar configuration, including each of the electrode members and overlying cap layer according to a specific embodiment. The non-planar structure can be compensated using one or more of each of the power supply device that selectively provides voltages to cause changes in illumination in each of the regions according to a specific embodiment. Although the backlight member is non-planar, it can be selectively driven to cause an appearance of planar illumination or patterned illumination or any combination of these, and the like. Of course, one of ordinary skill in the art would recognize other variations, modifications, and alternatives.

Although the above has been illustrated in terms of specific hardware features, it would be recognized that many variations, alternatives, and modifications can exist. For example, any of the hardware features can be further combined, or even separated. Further details of certain methods according to the present invention can be found throughout the present specification and more particularly below.

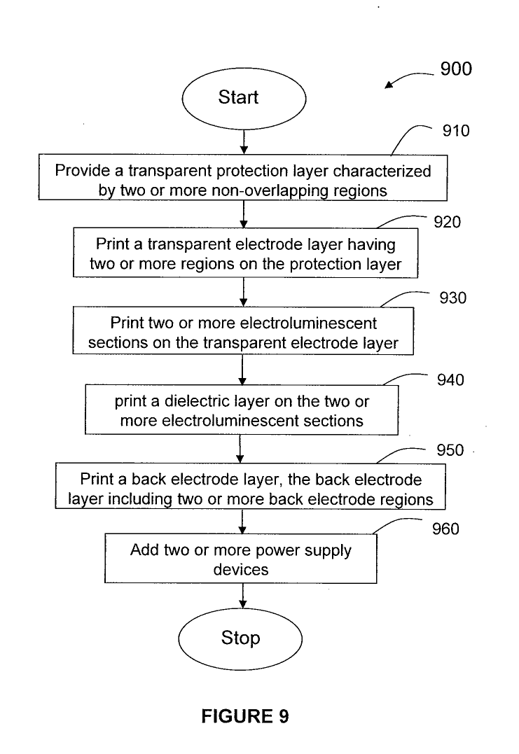

According to another embodiment of the invention, a method for manufacturing a luminescent device for a keyboard apparatus can be outline below. The method is also summarized in the simplified flow chart in FIG. 9.
1. (Process 910) providing a transparent protection layer characterized by two or more non-overlapping regions;
2. (Process 920) printing a transparent electrode layer on the transparent protection layer, the transparent electrode layer including two or more transparent electrode regions, each of the two or more transparent electrode region coupled to a corresponding one of the two or more non-overlapping regions;
3. (Process 930) printing two or more electroluminescent sections on the transparent electrode layer, each of the two or more electroluminescent sections coupled to a corresponding one of the two or more transparent electrode regions;
4. (Process 940) printing a dielectric layer on the two or more electroluminescent sections, the dielectric layer including two or more dielectric regions, each of the two or more dielectric regions coupled to a corresponding one of the electroluminescent segments;
5. (Process 950) printing a back electrode layer, the back electrode layer including two or more back electrode regions, each of the two or more back electrode regions coupled to a corresponding one of the two or more dielectric regions; and
6. (Process 960) adding two or more power supply devices, each of the two or more power supply devices being coupled to a corresponding one of the back electrode regions and being coupled to a corresponding one of the transparent electrode regions for providing luminescence over a corresponding one of the non-overlapping regions.

In an embodiment, the method also includes printing an insulator layer covering the back electrode layer, the dielectric layer, the electroluminescent sections, and the transparent electrode layer. In some embodiments, the printing process includes a screen printing process. In an embodiment, at least one of the two or more electroluminescent sections is characterized by a first color and at least another one of the two or more electroluminescent sections is characterized by a second color, the first color being different from the second color.

In a specific embodiment, a first one of the two or more power supply devices provides a first voltage and a second one of the two or more power supply devices provides a second voltage, the first voltage being different from the second voltage. In an embodiment, the first voltage and the second voltage provide substantially similar luminescent brightness in corresponding first and second non-overlapping regions. In an embodiment, a first one of the two or more power supply devices provides a first AC voltage characterized by a first frequency and a second one of the two or more power supply devices provides a second AC voltage characterized by a second frequency, the first frequency being different from the second frequency. In a specific embodiment, the first AC voltage and the second AC voltage provides substantially similar luminescent brightness in corresponding first and second non-overlapping regions.

In an embodiment, the method also includes adding a capacitor coupled to a corresponding transparent electrode region and a corresponding back electrode region for fine-tuning luminescent brightness over a corresponding one of the non-overlapping regions. In an embodiment, the method also includes providing a first conductive material between two adjacent transparent electrode regions in the transparent electrode layer, the first conductive material being electrically grounded to insulate the two adjacent transparent electrode regions. In another embodiment, the method includes providing a second conductive material between two adjacent back electrode regions in the back electrode layer, the second conductive material being electrically grounded to insulate the two adjacent back electrode regions.

In another embodiment, the method provides ground connection, which includes the following processes:
1. providing a first conductive material between two adjacent transparent electrode regions in the transparent electrode layer, the first conductive material being electrically grounded to insulate the two adjacent transparent electrode regions;
2. adding a second conductive material between two adjacent back electrode regions in the back electrode layer, the second conductive material being electrically grounded to insulate the two adjacent back electrode regions; and
3. coupling the first conductive material electrically to the second conductive material.

In another embodiment, the transparent electrode layer further includes a second plurality of conductive material, each of the second plurality of conductive material being disposed between each pair of adjacent transparent electrode regions in the transparent electrode layer, second plurality of conductive material being electrically grounded In yet another embodiment, the back electrode layer further includes a second plurality of conductive material, each of the second plurality of conductive material being disposed between each pair of adjacent back electrode regions in the back electrode layer, each of the second plurality of conductive material being electrically grounded. In a specific embodiment, each of the two or more power supply devices comprises a DC-to-AC inverter.

The above sequence of processes provides a method for manufacturing a luminescent device for a keyboard apparatus according to an embodiment of the present invention. As shown, the method uses a combination of processes including providing separate luminescent devices and power supplies to provide lighting to different regions of a keyboard. Other alternatives can also be provided where steps are added, one or more steps are removed, or one or more steps are provided in a different sequence without departing from the scope of the claims herein.

According to another embodiment, the present invention provides a keyboard apparatus. In the keyboard apparatus, a housing includes a plurality of key pads spatially disposed within the housing. Each of the key pads is depressible upon touch by a user. The plurality of key pads are distributed in a plurality of non-overlapping keyboard regions, and each of the non-overlapping regions includes fewer than all of the plurality of keypads. The keyboard apparatus also includes an optically transparent circuit board coupled to a backside of each of the key pads. The keyboard apparatus further includes a plurality of electroluminescent segments arranged in a non-planar configuration. Each of the plurality of electroluminescent segments includes one of a corresponding plurality of power supply devices. Each electroluminescent segment provides electromagnetic radiation to a respective non-overlapping keyboard region for lighting key pads in the respective non-overlapping keyboard region. In an embodiment, each of the non-overlapping regions includes fewer than all of the plurality of keypads.

In a specific embodiment of the keyboard apparatus, at least one of the plurality of electroluminescent segments is characterized by a first color and at least one of the plurality of electroluminescent segments is characterized by a second color. The first color is different from the second color. In an embodiment, a first one of the plurality of power supply devices provides a first voltage and a second one of the plurality of power supply devices provides a second voltage. The first voltage is different from the second voltage. In an embodiment, the first voltage and the second voltage provides substantially similar luminescent brightness.

In another embodiment of the keyboard apparatus a first one of the plurality power supply devices provides a first AC voltage characterized by a first frequency and a second one of the two or more power supply devices provides a second AC voltage characterized by a second frequency. The first frequency is different from the second frequency. In an embodiment, the first AC voltage and the second AC voltage provides substantially similar luminescent brightness in corresponding first and second non-overlapping keyboard regions. In a specific embodiment, the keyboard apparatus also includes a capacitor coupled to a corresponding electroluminescent segment for fine-tuning luminescent brightness over a corresponding one of the non-overlapping keyboard regions.

According to an alternative embodiment, the invention provides a keyboard apparatus. A housing of the keyboard apparatus includes a plurality of key pads spatially disposed within the housing. Each of the key pads is depressible upon touch by a user. The plurality of key pads is distributed in a plurality of non-overlapping keyboard regions, and each of the non-overlapping regions including fewer than all of the plurality of keypads. The keyboard includes an optically transparent circuit board coupled to a backside of each of the key pads. The keyboard also includes a luminescent apparatus which in turn includes a plurality of electroluminescent segments in a substantially non-planar configuration. Each of the plurality of electroluminescent segments includes one of a corresponding plurality of power supply devices. Each of the plurality of electroluminescent segments providing electromagnetic radiation to a respective non-overlapping keyboard region for lighting key pads in the respective non-overlapping keyboard region. In a specific embodiment, each of the non-overlapping regions has fewer than all of the plurality of keypads.

In an embodiment, the plurality of key pads include at least twenty six key pads. In another embodiment, each of the electroluminescent segments includes a phosphor-containing material. In a specific embodiment of the keyboard apparatus, the luminescent apparatus can be implemented as a multiple segment luminescent device as discussed above with reference to FIG. 8.

Although the above has been illustrated in terms of specific hardware features, it would be recognized that many variations, alternatives, and modifications can exist. For example, any of the hardware features can be further combined, or even separated. Further details of certain methods according to the present invention can be found throughout the present specification and more particularly below.

According to yet another embodiment, the invention provides a method for making a keyboard apparatus. First, a housing is provided. The housing includes a plurality of key pads spatially disposed within the housing. Each of the key pads is depressible upon touch by a user, and the plurality of key pads are distributed in a plurality of non-overlapping keyboard regions. The method includes providing an optically transparent circuit board coupled to a backside of each of the key pads. The method also includes providing a luminescent apparatus including a plurality of electroluminescent segments. Each of the second plurality of electroluminescent segments includes one of a corresponding plurality of power supply devices. Each of the plurality of electroluminescent segments provides electromagnetic radiation to a respective non-overlapping keyboard region for lighting key pads in the respective non-overlapping keyboard region.

In an embodiment, the plurality of key pads include at least twenty six key pads. In another embodiment, each of the electroluminescent segments includes a phosphor-containing material. In a specific embodiment of the method for making the keyboard apparatus, the luminescent apparatus can be made using the method discussed above with reference to Processes 910-960 and luminescent apparatus 800 in FIG. 8. Here luminescent apparatus 800 is used as a backlight member in the keyboard 100. As shown in FIG. 8, luminescent apparatus 800 has a substantially non-planar configuration, including each of the electrode members and overlying cap layer according to a specific embodiment. Each of the power supply device can selectively provide voltages to cause changes in illumination in each of the regions according to a specific embodiment. Although the luminescent apparatus is non-planar, it can be selectively driven to cause an appearance of planar illumination or patterned illumination or any combination of these, and the like. Of course, one of ordinary skill in the art would recognize other variations, modifications, and alternatives.

The above sequence of processes provides a method for manufacturing a keyboard apparatus according to an embodiment of the present invention. As shown, the method uses a combination of processes including providing separate luminescent devices and power supplies to provide lighting to different regions of a keyboard. Other alternatives can also be provided where steps are added, one or more steps are removed, or one or more steps are provided in a different sequence without departing from the scope of the claims herein.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. An electroluminescent apparatus, comprising:
a transparent protection layer characterized by two or more non-overlapping regions;
a transparent electrode layer, the transparent electrode layer including two or more transparent electrode regions, each of the two or more transparent electrode regions coupled to a corresponding one of the two or more non-overlapping regions;
two or more electroluminescent sections, each of the two or more electroluminescent sections coupled to a corresponding one of the two or more transparent electrode regions;
a dielectric layer, the dielectric layer including two or more dielectric regions, each of the two or more dielectric regions coupled to a corresponding one of the electroluminescent segments;
a back electrode layer, the back electrode layer including two or more back electrode regions, each of the two or more back electrode regions coupled to a corresponding one of the two or more dielectric regions; and
two or more power supply devices, each of the two or more power supply devices being coupled to a corresponding one of the back electrode regions and being coupled to a corresponding one of the transparent electrode regions for providing luminescence over a corresponding one of the non-overlapping regions.

2. The electroluminescent apparatus of claim 1, wherein at least one of the two or more electroluminescent sections is characterized by a first color and at least another one of the two or more electroluminescent sections is characterized by a second color, the first color being different from the second color.

3. The electroluminescent apparatus of claim 1, wherein a first one of the two or more power supply devices provides a first voltage and a second one of the two or more power supply devices provides a second voltage, the first voltage being different from the second voltage.

4. The electroluminescent apparatus of claim 2, wherein the first voltage and the second voltage provides substantially similar luminescent brightness in corresponding first and second non-overlapping regions.

5. The electroluminescent apparatus of claim 1, wherein a first one of the two or more power supply devices provides a first AC voltage characterized by a first frequency and a second one of the two or more power supply devices provides a second AC voltage characterized by a second frequency, the first frequency being different from the second frequency.

6. The electroluminescent apparatus of claim 5, wherein the first AC voltage and the second AC voltage provide substantially similar luminescent brightness in corresponding first and second non-overlapping regions.

7. The electroluminescent apparatus of claim 1, further comprising a capacitor coupled to a corresponding transparent electrode region and a corresponding back electrode region for fine-tuning luminescent brightness over a corresponding one of the non-overlapping regions.

8. The electroluminescent apparatus of claim 1, wherein each of the electroluminescent sections comprises a phosphor-containing material.

9. The electroluminescent apparatus of claim 1, further comprising a first conductive material between two adjacent transparent electrode regions in the transparent electrode layer, the first conductive material being electrically grounded to insulate the two adjacent transparent electrode regions.

10. The electroluminescent apparatus of claim 1, further comprising a second conductive material between two adjacent back electrode regions in the back electrode layer, the second conductive material being electrically grounded to insulate the two adjacent back electrode regions.

11. The electroluminescent apparatus of claim 1, further comprising:
a first conductive material between two adjacent transparent electrode regions in the transparent electrode layer, the first conductive material being electrically grounded to insulate the two adjacent transparent electrode regions; and
a second conductive material between two adjacent back electrode regions in the back electrode layer, the second conductive material being electrically grounded to insulate the two adjacent back electrode regions;
wherein the first conductive material is electrically coupled to the second conductive material.

12. The electroluminescent apparatus of claim 1, wherein the transparent electrode layer further comprises a second plurality of conductive material, each of the second plurality of conductive material being disposed between each pair of adjacent transparent electrode regions in the transparent electrode layer, second plurality of conductive material being electrically grounded.

13. The electroluminescent apparatus of claim 1, wherein the back electrode layer further comprises a second plurality of conductive material, each of the second plurality of conductive material being disposed between each pair of adjacent back electrode regions in the back electrode layer, each of the second plurality of conductive material being electrically grounded.

14. The electroluminescent apparatus of claim 1, wherein each of the two or more power supply devices comprises a DC-to-AC inverter.

15. The electroluminescent apparatus of claim 1, wherein the transparent electrode layer comprises ITO.

16. The electroluminescent apparatus of claim 1, wherein the transparent protection layer comprises a PET layer or a glass layer.

17. An electroluminescent apparatus, comprising:
a protection layer characterized by two or more non-overlapping regions;
a back electrode layer, the back electrode layer including two or more back electrode regions, each of the two or more back electrode regions overlying a corresponding one of the two or more non-overlapping regions in the protection layer,
a bottom insulation layer, the bottom insulation layer including two or more bottom insulation regions, each of the two or more bottom dielectric regions overlying a corresponding one of the back electrode regions;
a phosphor layer, the phosphor layer including two or more of phosphor regions, each of the two or more phosphor regions overlying a corresponding one of the back electrode layers;
a transparent electrode layer, the transparent electrode layer including two or more transparent electrode regions, each of the two or more transparent electrode region overlying a corresponding one of the phosphor regions; and
two or more power supply devices, each of the two or more power supply devices being coupled to a corresponding one of the back electrode regions and a corresponding one of the transparent electrode regions for providing luminescence over a corresponding one of the non-overlapping regions.

18. A keyboard apparatus comprising:
a housing including a plurality of key pads spatially disposed within the housing, each of the key pads being depressible upon touch by a user, the plurality of key pads being distributed in a plurality of non-overlapping keyboard regions, each of the non-overlapping regions including fewer than all of the plurality of keypads;
an optically transparent circuit board coupled to a backside of each of the key pads; and
a plurality of electroluminescent segments arranged in a non-planar configuration, each of the plurality of electroluminescent segments including one of a corresponding plurality of power supply devices, each of the plurality of electroluminescent segments providing electromagnetic radiation to a respective non-overlapping keyboard region for lighting key pads in the respective non-overlapping keyboard region, each of the non-overlapping regions including fewer than all of the plurality of keypads.

19. The keyboard apparatus of claim 18, wherein at least one of the plurality of electroluminescent segments is characterized by a first color and at least one of the plurality of electroluminescent segments is characterized by a second color, the first color being different from the second color.

20. The keyboard apparatus of claim 18, wherein a first one of the plurality of power supply devices provides a first voltage and a second one of the plurality of power supply devices provides a second voltage, the first voltage being different from the second voltage.

21. The keyboard apparatus of claim 20, wherein the first voltage and the second voltage provides substantially similar luminescent brightness in corresponding first and second non-overlapping keyboard regions.

22. The keyboard apparatus of claim 18, wherein a first one of the plurality power supply devices provides a first AC voltage characterized by a first frequency and a second one of the two or more power supply devices provides a second AC voltage characterized by a second frequency, the first frequency being different from the second frequency.

23. The keyboard apparatus of claim 22, wherein the first AC voltage and the second AC voltage provides substantially similar luminescent brightness in corresponding first and second non-overlapping keyboard regions.

24. The keyboard apparatus of claim 18, further comprising a capacitor coupled to a corresponding electroluminescent segment for fine-tuning luminescent brightness over a corresponding one of the non-overlapping keyboard regions.

25. A keyboard apparatus comprising:
a housing including a plurality of key pads spatially disposed within the housing, each of the key pads being depressible upon touch by a user, the plurality of key pads being distributed in a second plurality of non-overlapping keyboard regions, each of the non-overlapping regions including fewer than all of the plurality of keypads;
an optically transparent circuit board coupled to a backside of each of the key pads; and
a luminescent apparatus including a plurality of electroluminescent segments in a substantially non-planar configuration, each of the plurality of electroluminescent segments including one of a corresponding plurality of power supply devices, each of the plurality of electroluminescent segments providing electromagnetic radiation to a respective non-overlapping keyboard region for lighting key pads in the respective non-overlapping keyboard region, each of the non-overlapping regions including fewer than all of the plurality of keypads.

26. The keyboard apparatus of claim 25, wherein the plurality of key pads include at least twenty six key pads.

27. The keyboard apparatus of claim 25, wherein each of the electroluminescent segments comprises a phosphor-containing material.

28. The keyboard apparatus of claim 25, wherein the luminescent apparatus comprises:
a transparent protection layer characterized by two or more non-overlapping regions;
a transparent electrode layer, the transparent electrode layer including two or more transparent electrode regions, each of the two or more transparent electrode regions coupled to a corresponding one of the two or more non-overlapping regions;
two or more electroluminescent sections, each of the two or more electroluminescent sections coupled to a corresponding one of the two or more transparent electrode regions;
a dielectric layer, the dielectric layer including two or more dielectric regions, each of the two or more dielectric regions coupled to a corresponding one of the electroluminescent sections;
a back electrode layer, the back electrode layer including two or more back electrode regions, each of the two or more back electrode regions coupled to a corresponding one of the two or more dielectric regions; and
two or more power supply devices, each of the two or more power supply devices being coupled to a corresponding one of the back electrode regions and being coupled to a corresponding one of the transparent electrode regions for providing luminescence over a corresponding one of the non-overlapping regions.

29. The keyboard apparatus of claim 28, wherein at least one of the two or more electroluminescent sections is characterized by a first color and at least another one of the two or more electroluminescent sections is characterized by a second color, the first color being different from the second color.

30. The keyboard apparatus of claim 28, wherein a first one of the two or more power supply devices provides a first voltage and a second one of the two or more power supply devices provides a second voltage, the first voltage being different from the second voltage.

31. The keyboard apparatus of claim 28, wherein the first voltage and the second voltage provides substantially similar luminescent brightness in corresponding first and second non-overlapping regions.

32. The keyboard apparatus of claim 28, wherein a first one of the two or more power supply devices provides a first AC voltage characterized by a first frequency and a second one of the two or more power supply devices provides a second AC voltage characterized by a second frequency, the first frequency being different from the second frequency.

33. The keyboard apparatus of claim 32, wherein the first AC voltage and the second AC voltage provides substantially similar luminescent brightness in corresponding first and second non-overlapping regions.

34. The keyboard apparatus of claim 28, further comprising a capacitor coupled to a corresponding transparent electrode region and a corresponding back electrode region for fine-tuning luminescent brightness over a corresponding one of the non-overlapping regions.

35. The keyboard apparatus of claim 28, wherein the luminescent apparatus further comprises a first conductive material between two adjacent transparent electrode regions in the transparent electrode layer, the first conductive material being electrically grounded to insulate the two adjacent transparent electrode regions.

36. The keyboard apparatus of claim 28, wherein the luminescent apparatus further comprises a second conductive material between two adjacent back electrode regions in the back electrode layer, the second conductive material being electrically grounded to insulate the two adjacent back electrode regions.

37. The keyboard apparatus of claim 28, wherein the luminescent apparatus further comprises:
a first conductive material between two adjacent transparent electrode regions in the transparent electrode layer, the first conductive material being electrically grounded to insulate the two adjacent transparent electrode regions; and
a second conductive material between two adjacent back electrode regions in the back electrode layer, the second conductive material being electrically grounded to insulate the two adjacent back electrode regions;
wherein the first conductive material is electrically coupled to the second conductive material.

38. The keyboard apparatus of claim 28, wherein the transparent electrode layer further comprises a second plurality of conductive material, each of the second plurality of conductive material being disposed between each pair of adjacent transparent electrode regions in the transparent electrode layer, second plurality of conductive material being electrically grounded.

39. The keyboard apparatus of claim 28, wherein the back electrode layer further comprises a second plurality of conductive material, each of the second plurality of conductive material being disposed between each pair of adjacent back electrode regions in the back electrode layer, each of the second plurality of conductive material being electrically grounded.

40. The keyboard apparatus of claim 28, wherein each of the plurality of the two or more power supply devices comprises a DC-to-AC inverter.

41. The keyboard apparatus of claim 28, wherein the transparent electrode layer comprises ITO.

42. The keyboard apparatus of claim 28, wherein the transparent protection layer comprises a PET layer or a glass layer

43. The keyboard apparatus of claim 28, further comprising a DC power source coupled to the two or more power supply devices.

44. A method for manufacturing a luminescent device for a keyboard apparatus, the method comprising:
providing a transparent protection layer characterized by two or more non-overlapping regions;
printing a transparent electrode layer on the transparent protection layer, the transparent electrode layer including two or more transparent electrode regions, each of the two or more transparent electrode region coupled to a corresponding one of the two or more non-overlapping regions;
printing two or more electroluminescent sections on the transparent electrode layer, each of the two or more electroluminescent sections coupled to a corresponding one of the two or more transparent electrode regions;
printing a dielectric layer on the two or more electroluminescent sections, the dielectric layer including two or more dielectric regions, each of the two or more dielectric regions coupled to a corresponding one of the electroluminescent segments;
printing a back electrode layer, the back electrode layer including two or more back electrode regions, each of the two or more back electrode regions coupled to a corresponding one of the two or more dielectric regions; and
adding two or more power supply devices, each of the two or more power supply devices being coupled to a corresponding one of the back electrode regions and being coupled to a corresponding one of the transparent electrode regions for providing luminescence over a corresponding one of the non-overlapping regions.

45. The method of claim 44, further comprising printing an insulator layer covering the back electrode layer, the dielectric layer, the electroluminescent segments, and the transparent electrode layer.

46. The method of claim 44, wherein the printing of the back electrode layer comprises a screen printing process.

47. The method of claim 44, wherein the printing of the dielectric layer comprises a screen printing process.

48. The method of claim 44, wherein the printing of the two or more phosphor segments comprises a screen printing process.

49. The method of claim 44, wherein the printing of the transparent electrode layer comprises a screen printing process.

50. The method of claim 44, wherein at least one of the two or more electroluminescent sections is characterized by a first color and at least one of the two or more electroluminescent sections is characterized by a second color, the first color being different from the second color.

51. The method of claim 44, wherein a first one of the two or more power supply devices provides a first voltage and a second one of the two or more power supply devices provides a second voltage, the first voltage being different from the second voltage.

52. The electroluminescent apparatus of claim 51, wherein the first voltage and the second voltage provide substantially similar luminescent brightness in corresponding first and second non-overlapping regions.

53. The method of claim 44, wherein a first one of the two or more power supply devices provides a first AC voltage characterized by a first frequency and a second one of the two or more power supply devices provides a second AC voltage characterized by a second frequency, the first frequency being different from the second frequency.

54. The electroluminescent apparatus of claim 53, wherein the first AC voltage and the second AC voltage provides substantially similar luminescent brightness in corresponding first and second non-overlapping regions.

55. The method of claim 44, further adding a capacitor coupled to a corresponding transparent electrode region and a corresponding back electrode region for fine-tuning luminescent brightness over a corresponding one of the non-overlapping regions.

56. The method of claim 44, further comprising providing a first conductive material between two adjacent transparent electrode regions in the transparent electrode layer, the first conductive material being electrically grounded to insulate the two adjacent transparent electrode regions.

57. The method of claim 44, further comprising providing a second conductive material between two adjacent back electrode regions in the back electrode layer, the second conductive material being electrically grounded to insulate the two adjacent back electrode regions.

58. The method of claim 44, further comprising:
providing a first conductive material between two adjacent transparent electrode regions in the transparent electrode layer, the first conductive material being electrically grounded to insulate the two adjacent transparent electrode regions;
adding a second conductive material between two adjacent back electrode regions in the back electrode layer, the second conductive material being electrically grounded to insulate the two adjacent back electrode regions; and
coupling the first conductive material electrically to the second conductive material.

59. The method of claim 44, wherein the transparent electrode layer further comprises a second plurality of conductive material, each of the second plurality of conductive material being disposed between each pair of adjacent transparent electrode regions in the transparent electrode layer, second plurality of conductive material being electrically grounded

60. The method of claim 44, wherein the back electrode layer further comprises a second plurality of conductive material, each of the second plurality of conductive material being disposed between each pair of adjacent back electrode regions in the back electrode layer, each of the second plurality of conductive material being electrically grounded.

61. The method of claim 44, wherein each of the two or more power supply devices comprises a DC-to-AC inverter.

62. The method of claim 44, wherein the transparent electrode layer comprises ITO.

63. The method of claim 44, further comprising adding a PET layer or a glass layer overlying the transparent electrode layer.

64. A method for making a keyboard apparatus comprising:
providing a housing including a plurality of key pads spatially disposed within the housing, each of the key pads being depressible upon touch by a user, the plurality of key pads being distributed in a plurality of non-overlapping keyboard regions;
providing an optically transparent circuit board coupled to a backside of each of the key pads; and
providing a luminescent apparatus including a plurality of electroluminescent segments in a substantially non-planar configuration, each of the second plurality of electroluminescent segments including one of a corresponding plurality of power supply devices, each of the plurality of electroluminescent segments providing electromagnetic radiation to a respective non-overlapping keyboard region for lighting key pads in the respective non-overlapping keyboard region.

65. The method of claim 64, wherein the plurality of key pads include at least twenty six key pads.

66. The method of claim 64 wherein each of the electroluminescent segments comprises a phosphor-containing material.

67. The method of claim 64 wherein the luminescent apparatus further comprises:
a transparent protection layer characterized by two or more non-overlapping regions;
a transparent electrode layer, the transparent electrode layer including two or more transparent electrode regions, each of the two or more transparent electrode regions coupled to a corresponding one of the two or more non-overlapping regions;
two or more electroluminescent sections, each of the two or more electroluminescent sections coupled to a corresponding one of the two or more transparent electrode regions;
a dielectric layer, the dielectric layer including two or more dielectric regions, each of the two or more dielectric regions coupled to a corresponding one of the electroluminescent segments;
a back electrode layer, the back electrode layer including two or more back electrode regions, each of the two or more back electrode regions coupled to a corresponding one of the two or more dielectric regions; and
two or more power supply devices, each of the two or more power supply devices being coupled to a corresponding one of the back electrode regions and being coupled to a corresponding one of the transparent electrode regions for providing luminescence over a corresponding one of the non-overlapping regions.

68. The method of claim 67, wherein at least one of the two or more electroluminescent sections is characterized by a first color and at least another one of the two or more electroluminescent sections is characterized by a second color, the first color being different from the second color.

69. The method of claim 67, wherein a first one of the two or more power supply devices provides a first voltage and a second one of the two or more power supply devices provides a second voltage, the first voltage being different from the second voltage.

70. The method of claim 67, wherein the first voltage and the second voltage provides substantially similar luminescent brightness in corresponding first and second non-overlapping regions.

71. The method of claim 67, wherein a first one of the two or more power supply devices provides a first AC voltage characterized by a first frequency and a second one of the two or more power supply devices provides a second AC voltage characterized by a second frequency, the first frequency being different from the second frequency.

72. The method of claim 67, wherein the first AC voltage and the second AC voltage provides substantially similar luminescent brightness in corresponding first and second non-overlapping regions.

73. The method of claim 67, further comprising a capacitor coupled to a corresponding transparent electrode region and a corresponding back electrode region for fine-tuning luminescent brightness over a corresponding one of the non-overlapping regions.

74. The method of claim 67, wherein each of the electroluminescent sections comprises a phosphor-containing material.

75. The method of claim 67 wherein the luminescent apparatus further comprises a first conductive material between two adjacent transparent electrode regions in the transparent electrode layer, the first conductive material being electrically grounded to insulate the two adjacent transparent electrode regions.

76. The method of claim 67 wherein the luminescent apparatus further comprises a second conductive material between two adjacent back electrode regions in the back electrode layer, the second conductive material being electrically grounded to insulate the two adjacent back electrode regions.

77. The method of claim 67 wherein the luminescent apparatus further comprises:
a first conductive material between two adjacent transparent electrode regions in the transparent electrode layer, the first conductive material being electrically grounded to insulate the two adjacent transparent electrode regions; and
a second conductive material between two adjacent back electrode regions in the back electrode layer, the second conductive material being electrically grounded to insulate the two adjacent back electrode regions;
wherein the first conductive material is electrically coupled to the second conductive material.

78. The method of claim 67 wherein the transparent electrode layer further comprises a second plurality of conductive material, each of the second plurality of conductive material being disposed between each pair of adjacent transparent electrode regions in the transparent electrode layer, second plurality of conductive material being electrically grounded

79. The method of claim 67 wherein the back electrode layer further comprises a second plurality of conductive material, each of the second plurality of conductive material being disposed between each pair of adjacent back electrode regions in the back electrode layer, each of the second plurality of conductive material being electrically grounded.

80. The method of claim 67 wherein each of the plurality of the two or more power supply devices comprises a DC-to-AC inverter.

81. The method of claim 67 wherein the transparent electrode layer comprises ITO.

82. The method of claim 67 wherein the transparent protection layer comprises a PET layer or a glass layer.

83. The method of claim 67 further comprising providing a DC power source coupled to the two or more power supply devices.
